(19) United States
(12) Patent Application Publication
(10) Pub. No.: US 2006/0245606 A1
(43) Pub. Date: Nov. 2, 2006

(54) Electret condenser microphone and manufacturing method thereof

(75) Inventors: Yung Chuan Hsieh, Taipei (TW); Chuh Yan Chen, Taoyuan County (TW); Jen Nan Feng, Taoyuan County (TW); Yu Ling Tseng, Taipei County (TW)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/131,969

(22) Filed: May 18, 2005

Related U.S. Application Data
(60) Provisional application No. 60/675,209, filed on Apr. 27, 2005.

(51) Int. Cl. H04R 25/00

(52) U.S. Cl. 381/191

(57) ABSTRACT

A microphone includes a housing, an acoustic port formed in the housing, a diaphragm disposed within the housing adjacent the acoustic port, a backplate assembly operably disposed within the housing in spaced relationship relative to the diaphragm and a circuit assembly disposed within the housing. A connecting member extends between the circuit assembly and the backplate assembly to secure mechanically the backplate assembly within the housing and to couple electrically the backplate assembly to the circuit assembly.

### CROSS-REFERENCE TO RELATED APPLICATIONS

This patent claims benefit under 35 U.S.C. §119(e) to provisional patent application Ser. No. 60/675,209, filed Apr. 27, 2005 (attorney docket no. 30521/3096).

### TECHNICAL FIELD

This patent generally relates to microphones and more particularly to an electret condenser microphone (ECM) that may be used in communication devices, audio devices or the like, and a method of manufacturing the same.

### BACKGROUND

Mobile communication technology has progressed rapidly in recent years. Consumers are increasingly using mobile communication devices such as cellular phones, web-enabled cellular telephones, Personal Digital Assistants (PDAs), hand-held computers, laptops, tablets and other devices capable of communication over public or private communication networks. The expansion of cellular networks and technological advancements in mobile communications technology has resulted in more consumers using mobile communication devices. This increased demand for communication devices drives improvements in the manufacturing processes, power consumption, reception, fabrication, and miniaturization of audio components incorporated in the mobile communication devices. Competitive pressures among suppliers of mobile communication devices increase the demand for smaller, less expensive, and better performing miniature capacitor microphones.

Generally, speaking, a variety of conventional electret condenser microphones (ECMs) have been used for communication devices. A prior art ECM comprises a dust guard, a housing with an acoustic port, a vibratory diaphragm, a spacer, an insulating body, a backplate assembly, and a printed circuit board (PCB). The PCB includes a conductive ring, a ground connection, an output connection, and an input connection operably mounted to the top surface of the PCB. As the size of the ECM is reduced, limited space is available to accommodate the terminal connection, the insulating body and the conductive ring resulting in increase interference in the PCB. Apart for pursuit of miniaturization, these microphones experience poor radio frequency interference (RFI) suppression in the presence of a communication device such as cellular phone and thereby making the microphone less attractive for such applications.

### BRIEF DESCRIPTION OF THE DRAWINGS

For a more complete understanding of the disclosure, reference should be made to the following detailed description and accompanying drawings wherein:

FIG. 1 is an exploded view of an electret condenser microphone; and

FIG. 2 is a cross sectional view of an electret condenser microphone.

The drawings are for illustrative purposes only and are not intended to be to scale.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

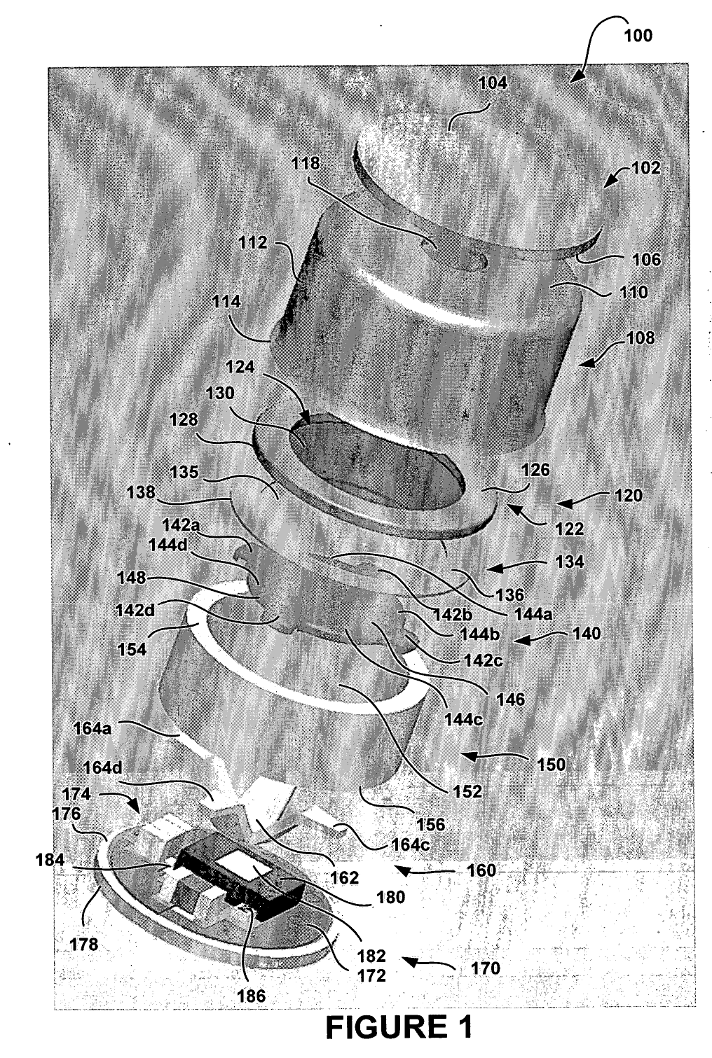

FIG. 1 is an exploded view of a microphone 100 adapted for use as either an electret condenser microphone (ECM), an omnidirectional microphone, an unidirectional microphone, a noise canceling microphone, or other such device that can be used in virtually any type of communication device such as cellular phones, web-enabled cellular telephones, Personal Digital Assistants (PDAs), hand-held computers, Bluetooth wireless headset, digital cameras, other types of portable computing and Internet access appliances and devices, and the like, capable of communication over one or more public or private communication networks. The microphone 100 includes a diaphragm assembly 120, a spacer 134, a backplate assembly 140, a body assembly 150, a connection member 160, and a circuit assembly 170 disposed within a housing 108. The housing 108 may be a cup-shaped housing and consists an upper surface portion 110 and a side wall portion 112. In alternate embodiments, the housing 108 may take the form of various other shapes (e.g. rectangular, D-shaped, or trapezoid-shaped) and have a number of different sizes. In one preferred embodiment, the width of the microphone 100 is about 2.5 mm and having a height of about 1.5 mm. The side wall portion 112 of the housing terminates at a connecting surface 114, defining an opening 116. The connecting surface 114 may be initially formed with an outward flare to enable placement of the working components in the housing 108.

When all the working components are placed in final or closed position within the housing 108, the connecting surface 114 is bent or re-formed radially toward the center of the opening 116. This forming operation mechanically captures the circuit assembly 170 by the connecting surface 114, locking the other working components in position as well as electrically connecting the circuit assembly 170. The housing 108 is shown to have at least one layer. However, the housing 108 may be fabricated from alternating layers of conductive materials and non-conductive materials or a non-conductive substrate may have a conductive coating applied on the inside allowing electrical connection of the diaphragm assembly 120 to the circuit assembly 170. In one embodiment, the housing 108 is made of copper alloy.

At least one aperture or acoustic port 118 is introduced on the upper surface 110 of the housing 108 to allow acoustic waves to be transmitted to the diaphragm assembly 120. The acoustic port 118 may be formed in any suitable manner such as drilling, punching or molding. The acoustic port 118 allows acoustic energy corresponding to the sound pressure level changes to enter the housing 108. A dust guard 102 in the form of a shape corresponding to the shape of housing 108, but may take the form of various shapes not necessarily corresponding to the housing shape, and may have a number of different sizes. In one embodiment, the dust guard 102 is shown to have a circular shape corresponding to the circular shape of the housing 108. The dust guard may be made of cloth or felt having a first surface 104 and a second surface 106. The second surface 106 of the dust guard 102 is attached to the housing 108 by adhesive to cover the acoustic port 118. This helps to prevent debris from entering the microphone 100 damaging the working components disposed within the housing 108. The dust guard 102 may also improve the frequency response, create delay and provide directional response.

The diaphragm assembly 120 includes a support ring 122 and a diaphragm 124 attached to the support ring 122. The diaphragm assembly 120 has a shape that generally corresponds to that of the housing 108 but may take the form of various shapes and have a number of different of sizes in different embodiments. The support ring 122 may be made of copper plated nickel; however, any electrically conductive material or material including a conductive coating, including brass or tin may be utilized. The support ring 122 has a first surface 126 and a second surface 128. The first surface 126 of the support ring 122 is held in contact with the inner surface of the housing 108 and the second surface 128 is held in contact with the spacer 134. The diaphragm 124 is made of an electrically conductive material capable of vibrating in response to acoustic waves. One such material is a polyethylene terephthalate film, commonly available under the trademark Mylar. The diaphragm 124 has a first surface 130 and a second surface 132. The first surface 130 of the diaphragm 124 is attached to the second surface 128 of the support ring 122, for example, by bonding with adhesive. However, it will be understood by those or ordinary skill in the art that any form of joining would suffice, including compression, or mechanical attachment at the edges, and the like. The second surface 132 of the diaphragm 124 is coated with a layer of conductive material such as chromium forming an electrically active portion, commonly referred to as the movable electrode is held in contact with the space 134.

The spacer 134 is formed to include an aperture 135 and first and second surfaces, 136 and 138 respectively, for electrically isolating the diaphragm assembly 120 from other working components within the housing 108. The spacer 134 is made of an electrically insulating material such as Mylar having a thickness selected to provide the desired space or separation between the diaphragm assembly 120 and the backplate 140. The spacer 134 enables deflection of the diaphragm 124 toward the backplate assembly 140. The spacer 134 may have various shapes not necessarily corresponding to the housing shape and may have a number of different sizes. In one embodiment, the spacer 134 is shown to be circular in shape corresponding to the housing 108. The spacer 134 thickness and materials may vary depending on the requirements of the application. The spacer 134 is placed between the diaphragm assembly 120 and the backplate assembly 140 and is held in place by mechanical pressure exerted by the connecting surface 114 after it is closed over the circuit assembly 170. The first surface 136 of the spacer 134 is held in contact with the diaphragm 124. The second surface 138 of the spacer 134 is held in contact with the backplate assembly 140 and separates the diaphragm assembly 120 from the backplate assembly 140.

The backplate assembly 140 is formed, for example by punching from a metal blank, a disk shape having at least one protrusion 142 and at least one relief section 144. In the embodiment shown, the backplate assembly 140 includes a plurality of protrusions 142a-d and a plurality of relief portions 144a-d such as disclosed in U.S. patent application Ser. No. 10/801,371, the disclosure of which is herein incorporated by reference in its entirety for all purposes. The backplate assembly 140 is made of an electrically conducting material such as stainless steel; however, any conductive material or material including a conductive coating may be utilized. The backplate assembly 140 has a first surface 146 and a second surface 148. The first surface 146 of the backplate assembly 140 may be coated or covered with a polarized dielectric film or electret material such as Teflon. In operation, the backplate forms a fixed electrode and may be electrostatically charged to a predetermined surface charge, for example −360V. Formed in this manner, the backplate assembly 140 has the advantage of increased surface area under the center, or most mobile areas of the diaphragm 124, thereby increasing the electro-acoustic performance of the microphone 100. The backplate assembly 140 is held between the spacer 134 and the connecting member 160, and such embodiment will be discussed in greater detail.

The body assembly 150 is cylindrical shaped and is formed to include a central passage 152 and upper and lower surfaces 154 and 156, respectively. The body assembly 150 is disposed within the housing 108. The body assembly 150 may be molded in various shapes and sizes to suite the needs of the application. In one embodiment, the body assembly 150 is circular cylindrical in shape and is made of an electrically insulating material such as a molded polyethylene plastic. When assembled, the first surface 154 of the body assembly 150 is held in contact with the spacer 134 by the mechanical pressure of the connecting surface 114, as described above. The second surface 156 of the body assembly 150 is held in contact with the circuit assembly 170 after it is closed over the circuit assembly 170.

The connecting member 160 mechanically secures the backplate assembly 140 within the housing 102 and electrically couples the backplate assembly to the circuit assembly 170. The connecting member 160 is a spring-like member that extends between the backplate assembly 140 and the circuit assembly 170 to secure the backplate assembly 170 relative to the spacer 134. The connecting member 160 is further constructed using a conductive material so that the connecting member 160 also electrically couples the backplate assembly 140 to the circuit assembly 170.

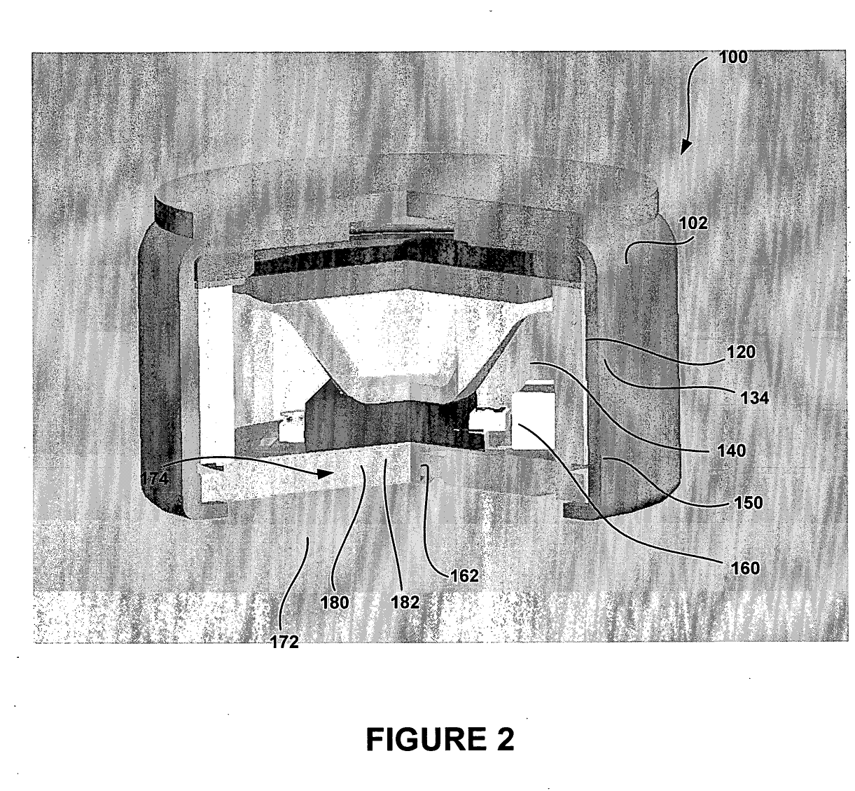

As illustrated in the embodiment shown in FIGS. 1 and 2, the connecting member 160 comprises a substantially planar engagement portion 162 at a center and a plurality of engagement legs 164a-d. The engagement legs 164a-d extend outwardly from the engagement portion 162. The engagement legs 164a-d are disposed at an angle of 90 degrees with respect to the other of the engagement legs 164a-d, and further form an angle with respect to the plane of the engagement portion 162. The engagement legs 164a-d have some flexibility, and therefore when positioned between the backplate assembly 140 and the circuit assembly 170 can compress slightly. The axial compression of the connecting member 160 accommodates some variation in the microphone assembly 100.

The connecting member 160 is further designed to electrically interconnect the backplate assembly 140 and the circuit assembly 170. In this regard, each engagement leg 164a-d of the connecting member 160 engages and electrically couples to a corresponding one of the protrusions 142a-d of the backplate assembly 140. The engagement portion 162 of the connecting member 160 abuts and is coupled to a conducting surface formed on the circuit assembly 170.

To both mechanically secure the backplate assembly 140 within the housing 102 and to electrically couple the backplate assembly 140 to the circuit assembly 170, the connecting member 160 may be made of a material having a high electrical conductivity and a high elastic content, e.g., a metal. For example, the connecting member 160 may be a Beryllium Copper (BeCu) alloy, or a similar material. The connecting member 160 may have a conductive coating, such as a gold coating particularly in the area of the bottom surface adjacent the circuit assembly 170. In this manner, the connecting member 160 both electrically couples to the circuit assembly 170 to transmit and provide acoustic signals thereto via the connecting member 160 and mechanically secures the backplate assembly 140 relative to the diaphragm assembly 120. Further, compressibility of the connecting member 160, keeps the electret layer 146 of the backplate assembly 140 from collapse caused by excessive heat and/or repetitive shock.

The circuit assembly 170 includes a circuit board 172, a plurality of electronic components 174 located on the circuit board 172. The circuit board 172 has a front surface 176 and a back surface 178. The circuit board 172 may be formed in various shapes and sizes corresponding to the housing or otherwise according to specific applications. The front surface 176 of the circuit board 172 may have printed wiring traces, a plurality of cavities (not shown), an output connection 184, an input connection 186, and the plurality of electronic components 174. The electronic components 174 may consist of a junction field effect transistor (JFET) 180, and at least two capacitors (not shown), which are provided to reduce the sensitivity to low and high radio frequency interference (RFI) signals generated by communications devices such as, for example, cellular phones. A gate connection (not shown) is mounted to the top surface of the JFET 180. The gate connection may be electrically coupled, for example by soldering, to a contact pad 182. The engagement portion 162 of the connecting member is position such that it engages the contact pad 182 and presses against the contact pad 182 to provide an electrical connection there between. Soldering or conductive adhesive may optionally be also used to secure the engagement portion 162 to the contract pad 182. The engagement portion 162 may alternatively be mechanically coupled or otherwise engaged with the contact pad 182. To ensure good electrical coupling, the contact pad 182 may be made of a conductive material such as gold plated nickel, which as a low inductance and a high radio frequency (RF) resistance. The contact pad 182 provides electrical coupling of the connecting member 160 to the top portion of the JFET 180 thereby connecting the gate connection to the backplate assembly 140 via the connecting member 160.

A microphone 100 according to the present invention has fewer parts and is easier to assemble than existing microphones. Once the electret portion is held in place with the connecting member 160 within the body assembly 150, the body assembly 150 is then press-fit into the housing 108 in contact with the spacer 134. The press-fit of the body assembly 150 restrains the underlying components to reduce shifting and damage that may occur during manufacturing. Further, the body assembly 150 makes it possible that the backplate assembly 140 and the diaphragm assembly 120 are electrically connected with the circuit assembly 170 with no unacceptable deformation of the connecting member 160. A device built in accordance with the inventive concepts disclosed herein has the advantage of reduced overall size while maintaining good electro-acoustic performance for sensitivity, noise, stability, compactness, robustness, and insensitivity to electromagnetic interference (EMI) and other external and environmental conditions, including shock and debris.

FIG. 2 is a cross-sectional view that will be referred to in conjunction with a description of an embodiment of a method of assembling the microphone. First, the diaphragm assembly 120 is inserted into the housing 108, opposed to the acoustic port 118. The spacer 134 is then inserted in the housing 108 with the first surface 136 of the spacer 134 facing the second surface 132 of the diaphragm assembly 120. The circuit assembly 170 is preassembled with a plurality of electronic components 174 located on the circuit board 172. Next the connection member 160 is attached to the circuit assembly 170 via the contact pad 182. The backplate assembly 140 is inserted into the body assembly 150. The first surface 146 of the backplate assembly 140 is oriented to be facing the second surface 138 of the spacer 134 when inserted into the housing 108. Each of the plurality of protrusions 142a-d is aligned and engage the plurality of engagement legs 164a-d of the connection member 160. So aligned and engaged with the protrusions 142a-d, the engagement legs 164a-d may optionally be secured, for example by soldering, conductive adhesive bonding or mechanically coupling. The body assembly 150 is then inserted into the housing 108. The backplate assembly 140, the spacer 134, and the diaphragm assembly 120 are restrained by the friction fit of the body assembly 150. After the diaphragm assembly 120, the spacer 134, the backplate assembly 140, the body assembly 150 and the connection member 160 are inserted into the housing 108, the back surface 178 of the circuit board 172 is captured by the connecting surface 114 of the housing 108 by mechanical fastening, crimping, welding, or adhesive bonding, for instance. In this position, the diaphragm assembly 140 and the backplate assembly 140 are electrically connected with the circuit assembly 170. In an alternative construction, the connecting member 160, and particularly the engagement legs 164a-d may be first secured to the protrusions 142a-d of the backplate assembly 140, that is mechanically and electrically coupled to the backplate assembly 140. Such an arrangement again facilitates assembly of the microphone 100.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

We claim:

1. A microphone comprising:
a housing,
an acoustic port formed in the housing,
a diaphragm disposed within the housing adjacent the acoustic port,
a backplate assembly operably disposed within the housing in spaced relationship relative to the diaphragm,
a circuit assembly including a transistor, the transistor formed to include a conductive attaching surface, and
a connecting member, the connecting member extending between the circuit assembly and the backplate assembly mechanically securing the backplate assembly within the housing and electrically coupling the backplate assembly to the attaching surface.

2. The microphone of claim 2, the connecting member being both mechanically and electrically coupled to the attaching surface.

3. The microphone of claim 1, the connecting member including a plurality of leg members, each leg member engaging a corresponding protrusion formed on a periphery of the backplate assembly.

4. The microphone of claim 3, wherein each leg member is electrically coupled to its corresponding protrusion.

5. The microphone of claim 4, wherein each leg member is mechanically coupled to its corresponding protrusion.

6. The microphone of claim 1, wherein the attaching surface comprises a contact pad forming on a surface of the transistor and the connecting member engaging the contact pad.

7. A method of making a microphone comprising:
providing a housing formed to include an acoustic port;
providing a diaphragm and disposing the diaphragm within the housing adjacent the acoustic port,
providing a backplate assembly and operably disposing the backplate assembly within the housing relative to the diaphragm,
providing a circuit assembly, the circuit assembly including a transistor formed to include a conductive attaching surface, and disposing the circuit assembly within the housing, and
providing a connecting member and extending the connecting member between the circuit assembly and the backplate assembly to mechanically secure the backplate assembly within the housing and to electrically couple the backplate assembly to the attaching surface.

8. The method of making a microphone of claim 7, comprising prior to disposing the circuit assembly within the housing, coupling the connecting member to the attaching surface.

9. The method of making a microphone of claim 7, comprising prior to disposing the circuit assembly within the housing, coupling the connecting member to the backplate assembly.

10. The method of making a microphone of claim 7, comprising providing the conductive attaching surface on a surface of the transistor and coupling the connecting member to the attaching surface.

11. The method of making a microphone of claim 7, wherein coupling the connecting member to the attaching surface comprises both mechanically and electrically coupling the connecting member to the attaching surface.

12. The method of making a microphone of claim 7, comprising providing the connecting member with a plurality of leg members, providing a corresponding number of protrusions on the backplate assembly, and engaging each leg member with its corresponding protrusion.

13. The method of making a microphone of claim 12, comprising electrically coupling each leg member with its corresponding protrusion.

14. The method of making a microphone of claim 12, comprising mechanically coupling each leg member with its corresponding protrusion.
